(19) United States
(12) Patent Application Publication
(10) Pub. No.: US 2012/0108121 A1
(43) Pub. Date: May 3, 2012

(54) TRANSPARENT FLUORESCENT STRUCTURES WITH IMPROVED FLUORESCENCE USING NANOPARTICLES, METHODS OF MAKING, AND USES

(76) Inventors: Jimmie R. Baran, JR., Prescott,, WI (US); Haeen Sykora, New Richmond, WI (US); Duane D. Fansler, Dresser, WI (US); Bruce B. Wilson, Woodbury, MN (US)

(21) Appl. No.: 13/378,551

(22) PCT Filed: Jun. 28, 2010
(86) PCT No.: PCT/US10/40177

§ 371 Date: Dec. 15, 2011

Related U.S. Application Data
(60) Provisional application No. 61/221,997, filed on Jun. 30, 2009.

(51) Int. Cl. B32B 5/16; D03D 15/00; B32B 9/04; B42D 15/00; C09K 11/06; B32B 5/02; D04H 13/00; B82Y 30/00

(52) U.S. Cl. 442/1; 428/221; 442/301; 442/414; 428/447; 283/85; 252/301.16; 252/301.35; 977/773

(57) ABSTRACT

Transparent fluorescent structures comprising a matrix and fluorescent nanoparticles disposed within the matrix. Each fluorescent nanoparticle comprises a substrate nanoparticle having a surface; and one or more fluorescent molecules that fluoresce light. Each fluorescent molecule is bonded to at least one reactive bonding site on the surface of the substrate nanoparticle. The fluorescent molecules are distributed among the substrate nanoparticles such that self-quenching of the fluorescent molecules is eliminated or at least reduced.

### SUMMARY OF THE INVENTION

According to one aspect of the present invention, a transparent fluorescent structure is provided which comprises a matrix, and a plurality of fluorescent nanoparticles disposed within the matrix, with the fluorescent nanoparticles comprising a plurality of substrate nanoparticles and fluorescent molecules. Each the fluorescent nanoparticle comprises a substrate nanoparticle having a surface; and one or more fluorescent molecules that fluoresce light, with each fluorescent molecule being bonded to at least one reactive bonding site on the surface of the substrate nanoparticle. The fluorescent molecules are distributed among the substrate nanoparticles such that self-quenching of the fluorescent molecules is eliminated or at least reduced.

The use of high concentrations of fluorescent molecules to produce a desired output light intensity exacerbates the self-quenching phenomenon, because the fluorescent molecules are so concentrated. Because the present invention is able to at least reduce self-quenching by bonding fluorescent molecules onto substrate nanoparticles, significantly fewer fluorescent molecules are needed to produce the same light intensity as compared to similar structures using fluorescent molecules not bonded onto substrate nanoparticles. In addition, even at relatively low concentrations of the fluorescent molecules, the present use of substrate nanoparticles enables the lower concentrations of fluorescent molecules to appear significantly brighter than they otherwise would have.

The matrix can comprise a continuous solid material, a discontinuous solid material or any combination thereof. The matrix can comprise one or more organic materials, inorganic materials, or composites thereof. The substrate nanoparticles have an average particle size of up to about 100 nm.

In another aspect of the present invention, a fluorescent nanoparticle/matrix precursor dispersion is provided which comprises a liquid, at least one polymeric element and fluorescent nanoparticles dispersed in the liquid. The polymeric element is dissolved in the liquid, suspended as a separate phase in the liquid or both. The dispersion can form a fluorescent structure like that described above, by removing the liquid (e.g., by evaporation), solidifying the liquid (e.g., by reaction with the polymeric element) or performing a combination thereof. In one embodiment, substrate nanoparticles and fluorescent molecules, instead of the fluorescent nanoparticles, can be individually dispersed in the liquid.

In an additional aspect of the present invention, a fluorescent nanoparticle/matrix dispersion is provided which comprises at least one powdered material and fluorescent nanoparticles dispersed in the powdered material. The dispersion either forms the fluorescent structure or is formable into the fluorescent structure by bonding the fluorescent nanoparticle dispersion into one mass.

In a further aspect of the present invention, an article is provided that comprises a transparent fluorescent structure according to the present invention. The present article can be, for example, a document, a tangible form of identification or a form of currency, with the transparent fluorescent structure defining a mechanism for authenticating the article. The transparent fluorescent structure can be, for example, in the form of an appliqué, dried invisible ink, dried paint, cured adhesive, cured clearcoat, cured hardcoat, or a combination thereof. The article may also comprise a fluorescent nanoparticle/matrix dispersion.

The light emitted by the transparent fluorescent structure can be light that is not visibly detectable by an unaided human eye, for example, because the intensity of the light is too low, the light has a wavelength outside the band of light visible to the normal unaided human eye, or a combination thereof.

In yet another aspect of the present invention, a method is provided for making a transparent fluorescent structure. The method comprises providing a plurality of substrate nanoparticles, providing a plurality of fluorescent molecules, bonding each of at least a portion of the fluorescent molecules to reactive sites on the surface of at least a portion of the substrate nanoparticles, providing a matrix precursor suitable for forming a matrix for the fluorescent nanoparticles, disposing at least a portion of the fluorescent nanoparticles into the matrix precursor, and treating the resulting fluorescent nanoparticle dispersion so as to form a transparent fluorescent structure. The fluorescent nanoparticles in the matrix comprise fluorescent molecules are distributed among the corresponding substrate nanoparticles such that self-quenching of the fluorescent molecules within the transparent fluorescent structure is eliminated or at least reduced.

### DEFINITIONS

“Nonreversible Covalent bond” or “nonreversibly covalently bonded” in the context of the present invention means a covalent bond that is nonreversible under physiologic conditions. This does not include a bond that is in equilibrium under physiologic conditions, such as a gold-sulfur bond, that would allow the attached groups to migrate from one particle to another. Also any foreign species containing —SH or —S—S— are capable of replacing the substitutes on the gold particles via gold-sulfur bond. As a result, the surface composition patterns may be disrupted.

“Nanoparticles” are herein defined as nanometer-sized particles. It is desirable for the nanoparticles to have an average particle size of no greater than about 200 nanometers (nm). It is desirable for the nanoparticles to have an average particle size that is less than or equal to about 100 nm, and preferably, within the range of from about 5 nm up to about 75 nm. It can be even more preferable for the nanoparticles to have an average particle size of less than or equal to about 20 nm. As used herein, references to the “size” or “diameter” of a particle both refer to the largest dimension of the particle (or agglomerate thereof).

In this context, an “agglomerate” or “agglomeration” refers to a mass of particles having a weak association between particles which may be held together by charge or polarity and can be broken down into smaller groups of particles and/or individual particles.

“Dispersible” nanoparticles are nanoparticles having solvent-dispersible groups bound (e.g., covalently) thereto in a sufficient amount to provide dispersibility in the solvent to the nanoparticles. In this context, “solvent dispersibility” means particles are in the form of individual particles not agglomerates.

“Dispersible groups” are monovalent groups that are capable of providing a hydrophilic surface thereby reducing, and preferably preventing, excessive agglomeration and precipitation of the nanoparticles in a solvent environment. Suitable solvents may include, e.g., water, tetrahydrofuran (thf), toluene, ethanol, methanol, methyl ethyl ketone (MEK), acetone, heptane, ethyl acetate, etc.

As used herein, a fluorescent structure according to the present invention is considered “transparent”, if light from the fluorescent nanoparticles is detectable from outside of the structure. Preferably the matrix material used according to the present invention is transparent to the light transmitted by the fluorescent material on the substrate nanoparticles. For example, when the light is visible to the normal unaided human eye, a transparent structure can include those that range from being translucent (i.e. allowing at least some detectable visible light) to crystal clear (i.e., that allow about 100% light transmission). Alternatively, when the light from the fluorescent material is not within the band visible to the normal unaided human eye (e.g., is ultra-violet (UV) or infrared (IR) light), the transparent structure may be opaque to visible light (i.e., allowing about 0% transmission of visible light therethrough) but still considered “transparent” to the light from the fluorescent material.

“Self-quenching” refers to the quenching of fluorescent light emission due to intermolecular interaction, when two identical or similar fluorescent molecules are too close in proximity. In general, increasing the distance between the two molecules will decrease their interaction and thus increase the intensity of their fluorescence.

The amount of fluorescent material bonded to the exterior surface of the substrate nanoparticles is considered not to be “self-quenching”, when the fluorescent molecules are sufficiently dispersed among the substrate nanoparticles that light emitted from the fluorescent molecules is detectable to the extent desired (e.g., visible light by the human eye), even though the same amount of fluorescent molecules would be self-quenching, if the fluorescent molecules were not so distributed among the substrate nanoparticles (e.g., if this amount of fluorescent dye material was concentrated on the surface of a single substrate rather than separated to the extent provided by being on the substrate nanoparticles). In other words, light emitted from this same amount of fluorescent molecules would not be detectable, if the fluorescent molecules were not so distributed among the substrate nanoparticles. The bonding of one or more fluorescent molecules to the nanoparticles is the mechanism used to obtain the spacing between the fluorescent molecules needed to prevent substantial self-quenching. Self-quenching is considered substantially reduced, when the use of the substrate nanoparticles enables the light intensity of the attached fluorescent material to be at least the minimum needed to be detectable for the desired application or use of the transparent fluorescent structure.

The term “polymer” or “polymeric” will be understood to include polymers, copolymers (e.g., polymers formed using two or more different monomers), oligomers and combinations thereof, as well as polymers, oligomers, or copolymers that can be formed in a miscible blend.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. In addition, the singular forms “a”, “an”, and “the” encompass embodiments having plural referents, unless the content clearly dictates otherwise. Thus, for example, a nanoparticle that comprises “a” surface bonding group can be interpreted to mean that the nanoparticle includes “one or more” a surface bonding groups.

As used herein, “a,” “an,” “the,” “at least one,” and “one or more” are used interchangeably. Thus, for example, a nanoparticle that comprises “a” fluorescent molecule-binding group can be interpreted to mean that the nanoparticle includes “one or more” fluorescent molecule-binding groups.

The term “and/or” means one or all of the listed elements or a combination of any two or more of the listed elements (e.g., preventing and/or treating an affliction means preventing, treating, or both treating and preventing further afflictions).

As used herein, the term “or” is generally employed in its sense including “and/or” unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF CERTAIN EMBODIMENTS

In describing preferred embodiments of the invention, specific terminology is used for the sake of clarity. The invention, however, is not intended to be limited to the specific terms so selected, and each term so selected includes all technical equivalents that operate similarly or perform a similar function.

In the practice of the present invention, a transparent fluorescent film, layer, coating or other structure can be provided that comprises a solid matrix in the form of a continuous or discontinuous structure, and a plurality of fluorescent nanoparticles encapsulated, encased, embedded, surrounded or otherwise disposed within the matrix. The fluorescent nanoparticles comprise a plurality of substrate nanoparticles and fluorescent molecules. Exemplary substrate nanoparticles can include silica, titania and zirconia, alumina zinc oxide, iron oxide, calcium phosphate, hydroxyapatite, as well as combinations thereof. Each of the fluorescent nanoparticles comprises a substrate nanoparticle having a surface and one or more fluorescent molecules (e.g., fluorescent dye molecules) that are preferably organic. Each fluorescent molecule is covalently bonded, preferably nonreversibly covalently bonded, or otherwise bonded (e.g., by chemisorption) directly, or indirectly through one or more intermediate molecules (e.g., a surface bonding group), to a reactive bonding site on the surface of the substrate nanoparticle. The fluorescent molecules are sufficiently distributed among the substrate nanoparticles such that self-quenching of the fluorescent molecules is eliminated or at least significantly reduced compared to the same amount of fluorescent molecules disposed together without being attached to the nanoparticles. Such self-quenching is considered significantly reduced, when the amount of fluorescent molecules in the matrix would not fluoresce a sufficiently detectable light intensity (i.e., a light intensity suitable for the desired application or use of the transparent fluorescent structure) if it were not for the fluorescent molecules being attached to substrate nanoparticles while in the matrix.

The matrix used according to the present invention can be in the form of or at least comprise a continuous solid material, a discontinuous solid material or any combination thereof. The matrix material can be a solid material comprising one or more organic materials, inorganic materials, or composites thereof. It can be desirable for the matrix material to be made from a natural or synthetic polymeric material and to be in the form of, for example, a plastic, cured adhesive, dried paint or dried ink. In addition, the matrix can comprise one or more organic materials, inorganic materials, or composites thereof. When in the form of a continuous structure, the matrix can be, e.g., in the form of a web, sheet, film, layer, coating, extrudate, casting, molding, any other continuous structure or any combination thereof. When in the form of a discontinuous structure, the matrix can be, e.g., in the form of a woven or nonwoven fibrous web, scrim, sheet, layer, paper, fabric, cloth or any combination thereof. The matrix can also be in the form of an organic powder (e.g., a polymeric powder, wood pulp, starches, carbohydrates, polysaccharides), inorganic powder (e.g., calcium carbonate powder, silica, titania and zirconia, alumina zinc oxide, iron oxide, calcium phosphate, hydroxyapatite, or any combination thereof.

The fluorescent nanoparticles are considered disposed within the matrix, when the surfaces of the fluorescent nanoparticles are sufficiently (a) covered with (e.g., when the fluorescent nanoparticles are completely or substantially encapsulated, encased, embedded or surrounded in a continuous matrix structure), (b) bonded to (e.g., when the fluorescent nanoparticles are adhered to the matrix structure), and/or (c) mechanically retained within (e.g., when the fluorescent nanoparticles are effectively locked within pores or other spaces between fibers in a woven or nonwoven fibrous matrix structure) enough matrix material that a substantial number of the fluorescent nanoparticles are spatially held together, completely or at least in part, by the matrix material. The number of fluorescent nanoparticles held together are considered substantial, when there are at least the minimum number of fluorescent nanoparticles needed to produce the intensity of fluorescence desired for a particular application or use.

The fluorescent nanoparticles can be spatially held together, completely or at least in part, by the matrix, for example, by being (a) chemically bonded to the matrix material (e.g., by using a matrix material that adhesively bonds to the fluorescent nanoparticles), (b) mechanically held together by being physically surrounded by the matrix material (e.g., by being locked in place between fibers forming a fibrous matrix material or embedded into a continuous matrix material that may or may not chemically bond to the fluorescent nanoparticles), or (c) a combination thereof. It may also be desirable for the surface area of each of the fluorescent nanoparticles to be completely or only partially (e.g., less than 90%, 80%, 70%, 60%, 50%, or 40%) covered by or otherwise disposed within the matrix.

Any effective combination of such matrix materials and structures can be used. For example, the fluorescent nanoparticles can be located between the fibers in a fibrous matrix layer, with the resulting fiber/nanoparticle composite layer disposed or sandwiched between two solid layers. In this way, the fluorescent nanoparticles can be effectively locked or held within the fibrous matrix layer, with or without the fluorescent nanoparticles being bonded to the fibers in the matrix. Of course, the fluorescent nanoparticles could simply be adhered to a fibrous matrix using a suitable adhesive (e.g., a transparent acrylic pressure sensitive adhesive, etc.). It has been found that when the fluorescent molecules are bonded to nanoparticles, the resulting fluorescent nanoparticles are less likely to find there way as deep into a fibrous matrix (e.g., a paper) as the fluorescent molecules would on their own. Therefore, it appears that the use of substrate nanoparticles help to keep the fluorescent molecules near the surface of the fibrous matrix.

Examples of fluorescent molecules or groups can include coumarin, fluorescein, fluorescein derivatives, rhodamine, and rhodamine derivatives. Combinations of different fluorescent molecules can be used if desired. It may be possible to use a combination of different particles with the same or different fluorescent molecules. For example, one type of nanoparticle in a mixture could be bonded with fluorescein and another type of particle could be bonded with rhodamine.

Each fluorescent molecule can be bonded (e.g., covalently bonded) directly to at least one or more reactive bonding sites on the surface of the substrate nanoparticle. The fluorescent molecules can be covalently bonded directly to the surface of the nanoparticles, or it is possible to attach fluorescent molecules to the surface of the nanoparticles through another molecule (e.g., avidin) noncovalently. It is also possible to attach a fluorescent molecule (e.g., carboxyfluorescein and aminofluorescein) through ionic or hydrophobic interactions. Each of the fluorescent molecules can also, or alternatively, be attached to at least one or more of the reactive bonding sites through a surface-bonding group. That is, each fluorescent molecule can be bonded to a surface-bonding group which is bonded to at least one or more of the reactive bonding sites on the surface of a substrate nanoparticle. Such surface-bonding group could include, for example, silanols, alkoxysilanes (e.g., trialkoxysilanes), or chlorosilanes. In addition, or alternatively, one or more of the fluorescent molecules can be non-covalently bonded (e.g., by chemisorption) to at least one or more reactive bonding sites on the surface of the substrate nanoparticle.

An example of a fluorescent compound is triethoxysilyl-substituted fluorescein. Those of ordinary skill in the art will recognize that a wide variety of other fluorescent compounds are useful in the present invention. Exemplary conditions for reacting such fluorescent compounds with substrate nanoparticles are described herein.

It is desirable for the substrate nanoparticles to have an average particle size of up to about 100 nm. To facilitate the transparency of the fluorescent structure, it can be preferable for the substrate nanoparticles to have an average particle size within the range of from about 5 nm up to about 75 nm. When nanoparticles having an average size greater than about 20 nm are used, it may be necessary to match refractive indices of the matrix and nanoparticles, in order to have a structure that is transparent. Therefore, it can be preferable for the substrate nanoparticles to have an average particle size of less than about 20 nm. Suitable nanoparticles of this invention typically have very large number of accessible reactive bonding sites. For example, silica nanoparticles have a large number of reactive silanol bonding sites (e.g., 5 nm particles can have up to about 270 accessible silanol groups, 20 nm particles can have up to about 3200 accessible silanol groups, 90 nm particles can have up to about 50,000 accessible silanol groups). Therefore, even a high percentage coverage by dispersible groups or other surface modifying agents does not preclude the attachment of a useful number of fluorescent compounds.

The fluorescent molecules fluoresce light which is either visible to the normal unaided human eye (i.e., light having a band of wavelengths that at least overlaps the band of wavelengths visible to the normal unaided human eye) or not visible to the normal unaided human eye (i.e., light having a wavelength outside the band of light visible to the normal unaided human eye such as, e.g., ultra-violet (UV) and/or infrared (IR) light). The transparent fluorescent structure can also be opaque to visible light (i.e., allowing about 0% transmission of visible light therethrough) but transparent to the light from the fluorescent molecules.

It is preferred that the fluorescent molecules are bonded to the substrate nanoparticles such that the fluorescent molecules exhibit no self-quenching (i.e., such that the fluorescent molecules produce the maximum detectable light intensity). It can be commercially acceptable, however, for self-quenching of the fluorescent molecules to only be reduced (i.e., for the fluorescent molecules to produce a light intensity suitable for the desired application or use of the transparent fluorescent structure). Therefore, the fluorescent molecules can be distributed among the substrate nanoparticles such that the amount of fluorescent molecules in the matrix would not fluoresce or otherwise produce a sufficiently detectable light intensity, if it were not for the fluorescent molecules being attached to substrate nanoparticles while in the matrix.

The transparent fluorescent structure can be formed from a fluorescent nanoparticle/matrix precursor dispersion (e.g., in the form of a mixture, suspension, or solution). Such a dispersion can comprise a liquid, at least one polymeric element, and fluorescent nanoparticles dispersed in the liquid. The polymeric element is dissolved in the liquid, suspended as a separate phase in the liquid, or both. In addition, the matrix of the transparent fluorescent structure can be formed by removing the liquid (e.g., by evaporating the liquid), solidifying the liquid (e.g., by reacting the liquid with the polymeric element) or a combination of both. In one embodiment, the transparent fluorescent structure can also be in the form of such a dispersion, where the substrate nanoparticles and fluorescent molecules are individually dispersed in the liquid, where they subsequently come together and form the fluorescent nanoparticles in situ in the liquid. Such a dispersion (i.e., capable of in situ formation of the fluorescent nanoparticles within the matrix) could be produced, e.g., by using a latex polymeric element in an aqueous reaction media, or by using substrate nanoparticles that solvate a polymeric substrate in an organic solvent as well as allow the bonding of fluorescent molecules to the nanoparticle surface. In either case, the substrate nanoparticles could have film forming functionality on the particle surface, as well as functionality for reacting and bonding with the fluorescent molecules.

The liquid in such dispersions can be a solvent that readily evaporates, e.g., in a one atmosphere of pressure environment. Examples of such liquid solvents can include, but are not limited to, water, tetrahydrofuran (thf), toluene, ethanol, methanol, etc. Alternatively, or in addition, the liquid can be an uncured polymeric material. That is, the liquid can be a molten thermoplastic polymeric material, or a non-crosslinked monomeric, oligomeric and/or other polymeric material of sufficiently low viscosity that the fluorescent nanoparticles, or substrate nanoparticles and fluorescent molecules, can be dispersed within the liquid.

It can be desirable to bond one or more dispersible groups to the surface of the substrate nanoparticles to facilitate the dispersal of the nanoparticles in the liquid. It is desirable for such dispersible groups to form a covalent bond, and preferably a nonreversible covalent bond, with the nanoparticle. The dispersible groups assist in dispersing the nanoparticles in a liquid solvent such as those described above. The dispersible groups can include carboxylic acid groups, sulfonic acid groups, phosphonic acid groups, salts, aliphatic or aromatic moieties, or combinations thereof. For certain embodiments, the dispersible groups may also include poly(alkylene oxide)-containing groups.

The transparent fluorescent structure can also be formed from a fluorescent nanoparticle/matrix precursor dispersion (e.g., in the form of a mixture, suspension, or solution) that comprises at least one powdered material and fluorescent nanoparticles dispersed in and preferably homogeneously throughout the powdered material. The powdered material comprises, e.g., powdered polymeric material or any other powdered material than can be formed into one mass. This dispersion can be formable into the transparent fluorescent structure by melting, fusing, sintering, agglomerating or otherwise bonding the fluorescent nanoparticle dispersion into one mass (e.g., by heating the dispersion at an appropriate temperature, for an appropriate period of time and under an appropriate applied pressure). Because nanoparticles can sinter at temperatures lower than larger masses of the same material, it is believed that such a dispersion may be formed into a fluorescent structure using heat, even though fluorescent molecules are typically sensitive to thermal degradation of their light output and intensity.

In an alternative embodiment, the transparent fluorescent structure can be in the form of a fluorescent nanoparticle/matrix dispersion (e.g., in the form of a mixture, suspension, or solution). This dispersion can comprise at least one powdered material and fluorescent nanoparticles dispersed in the powdered material. The powdered material forms the matrix and can comprise an organic powdered material (e.g., powdered polymeric material, wood pulp, starches, carbohydrates, polysaccharides, etc.), inorganic powdered material (e.g., calcium carbonate, silica, titania and zirconia, alumina zinc oxide, iron oxide, calcium phosphate, hydroxyapatite, etc.), any other powdered material or a combination thereof. Preferably, at least for some embodiments, the fluorescent nanoparticles are dispersed homogeneously throughout the powdered material. Such a powder dispersion can be used to make an article (e.g., cosmetics, drugs, etc.).

Various other articles can be made that include a transparent fluorescent structure according to the present invention. Such an article can include a transparent substrate (e.g., a film, layer, sheet, etc.) having a substrate surface, with the transparent fluorescent structure being a layer chemically (e.g., adhesively bonded), mechanically (e.g., laminated or otherwise sandwiched between two substrates) or otherwise attached to the substrate surface. Alternatively, such an article can include two substrates (e.g., a film, layer, sheet, etc.), with at least one of the substrates being transparent, and the transparent fluorescent structure being a layer chemically (e.g., adhesively bonded), mechanically (e.g., laminated or otherwise sandwiched between two substrates) or otherwise attached between the substrate.

Such an article can be in the form of a document (e.g., purchase orders or other contracts, manuscripts, research papers, screenplays, scripts, secret or other reports, formulas etc.), with the transparent fluorescent structure defining a security mechanism for authenticating the document. For example, the fluorescent light emitted by the fluorescent structure can be used to identify a particular entity (e.g., a government agency, company, group or person) as the source and/or author of the document, and thereby verify the legitimacy and/or ownership of the document, and/or verify the accuracy of the information in the document.

Such an article can also be a tangible form of identification (e.g., a drivers license, passport, immigration green card, photograph, etc.), with the transparent fluorescent structure defining a security mechanism for authenticating the form of identification. For example, the fluorescent light emitted by the fluorescent structure can be used to identify a particular entity (e.g., a government agency, company, group or person) with the form of identification, and thereby verify the legitimacy and/or ownership of the form of identification, and/or verify the accuracy of the information in the form of identification.

In addition, such an article can be a form of currency (e.g., credit or debit cards, paper money, coins, shares of stock, bearer or other bonds, personal, business or cashier checks, certificates of deposit, etc.), with the transparent fluorescent structure defining a security mechanism for authenticating the form of currency. For example, the fluorescent light emitted by the fluorescent structure can be used to identify a particular entity (e.g., a government agency, company, group or person) with the form of currency, and thereby verify the legitimacy and/or ownership of the form of currency, and/or verify the accuracy of the amount, account number, payer and payee identified on the form of currency.

The transparent fluorescent structure used in the above exemplary articles can be in the form of an appliqué, dried invisible ink, dried paint, cured adhesive, cured clearcoat, cured hardcoat, or a combination thereof.

To facilitate their use as a security feature, the transparent fluorescent structures used in the above described exemplary articles (e.g., documents, forms of identification, forms of currency, etc.) can be made to emit light that is not visibly detectable by a normal unaided human eye. For example, the emitted light may be invisible to a normal unaided human eye, because the intensity of the light is too low, the light has wavelengths outside the band of light visible to the normal unaided human eye (e.g., ultra-violet (UV) and/or infrared (IR) light), or a combination thereof.

A transparent fluorescent structure according to the present invention can be made, for example, by providing a plurality of substrate nanoparticles, providing a plurality of fluorescent molecules that fluoresce light, bonding each of at least a portion of the fluorescent molecules to reactive sites on the surface of at least a portion of the substrate nanoparticles, providing a matrix precursor suitable for forming a matrix for the fluorescent nanoparticles, disposing at least a portion of the fluorescent nanoparticles into the matrix precursor, and treating the resulting fluorescent nanoparticle dispersion so as to form a transparent fluorescent structure. The fluorescent nanoparticles in the matrix comprise fluorescent molecules are sufficiently distributed among the corresponding substrate nanoparticles such that self-quenching of the fluorescent molecules within the transparent fluorescent structure is eliminated or at least reduced.

Each of the substrate nanoparticle has a surface comprising a plurality of reactive bonding sites. The fluorescent molecules are preferably organic fluorescent molecules (e.g., fluorescent dye molecules). The fluorescent molecules can be covalently bonded, preferably nonreversibly covalently bonded, or otherwise bonded directly, or indirectly through one or more intermediate molecules (e.g., a surface bonding group) to a reactive bonding site on the surface of each of at least a portion of the substrate nanoparticles so as to form a plurality of fluorescent nanoparticles. The matrix precursor can be, e.g., a curable thermoplastic or thermosettable plastic resin, adhesive, paint, ink or a combination thereof in a dry or liquid form that is suitable for forming the matrix of the particular transparent fluorescent structure of interest. The fluorescent nanoparticles can be disposed into the matrix precursor so as to form a fluorescent nanoparticle dispersion (e.g., in the form of a mixture, suspension, or solution). The resulting dispersion can be cured (e.g., by cross-linking a thermoset polymeric material), solidified (e.g., by cooling a molten thermoplastic polymeric material), dried (e.g., by evaporating the solvent from a liquid paint or ink) or otherwise treated so as to form a transparent fluorescent film, layer, coating or other structure.

The fluorescent nanoparticle dispersion can be extruded, cast, molded, coated, laminated or otherwise formed into a desired shape or article, before or during the process of treating the dispersion so as to form the transparent fluorescent structure of interest. When the fluorescent nanoparticle dispersion is a powder dispersion, a powder-based article (e.g., cosmetics, drugs, etc.) can be formed by packaging or otherwise containing the powder dispersion, before or during the treating process.

The fluorescent nanoparticle dispersion can comprise a liquid, at least one polymeric element, and either the fluorescent nanoparticles, the nanoparticles and fluorescent molecules, or both. The polymeric element can be dissolved in the liquid, suspended as a separate phase in the liquid or both. The fluorescent nanoparticles are dispersed and preferably suspended in the liquid. And, the treatment of the fluorescent nanoparticle dispersion can further comprise removing the liquid from the fluorescent nanoparticle dispersion (e.g., by evaporation, when the liquid readily evaporates) or converting the liquid to a solid (e.g., by reaction with the polymeric element).

The liquid can be a solvent that readily evaporates, e.g., in a one atmosphere of pressure environment, and the treating cause evaporation of the liquid. The liquid can be an uncured polymeric material, with the treating causes solidification, and optionally curing, of the liquid. That is, the liquid is a molten thermoplastic polymeric material, or a non-crosslinked monomeric, oligomeric and/or other polymeric material.

In another embodiment, the fluorescent nanoparticle dispersion comprises at least one powdered material and the fluorescent nanoparticles, with the fluorescent nanoparticles being dispersed in the powdered material. It can be preferable for the fluorescent nanoparticles to be dispersed homogeneously throughout the powdered material. The treatment of the fluorescent nanoparticle dispersion can comprise melting, fusing, sintering, agglomerating, packaging or otherwise forming the fluorescent nanoparticle dispersion into one mass (e.g., by heating the dispersion under an applied pressure, putting an amount of the dispersion into a container).

### EXEMPLARY EMBODIMENTS

1. A transparent fluorescent structure comprising:
a matrix; and
a plurality of fluorescent nanoparticles disposed within said matrix, with said fluorescent nanoparticles comprising a plurality of substrate nanoparticles and fluorescent molecules, and each said fluorescent nanoparticle comprising:
   a substrate nanoparticle having a surface; and
   one or more fluorescent molecules that fluoresce light, with each fluorescent molecule being bonded to a reactive bonding site on the surface of said substrate nanoparticle,
wherein said fluorescent molecules are distributed among said substrate nanoparticles such that self-quenching of said fluorescent molecules is at least reduced.
   2. The transparent fluorescent structure according to embodiment 1, wherein said matrix comprises a continuous solid material, a discontinuous solid material or any combination thereof.
   3. The transparent fluorescent structure according to embodiment 1 or 2, wherein said matrix is in the form of a continuous structure.

4. The transparent fluorescent structure according to embodiment 3, wherein said matrix is in the form of a web, sheet, film, layer, coating, extrudate, casting, molding or any combination thereof.

5. The structure according to embodiment 1 or 2, wherein said matrix is in the form of a discontinuous structure.
6. The transparent fluorescent structure according to embodiment 5, wherein said matrix is in the form of a woven or nonwoven fibrous web, scrim, sheet, layer, paper, fabric, cloth or any combination thereof.
7. The transparent fluorescent structure according to embodiment 5, wherein said matrix is in the form of a powder.
8. The transparent fluorescent structure according to any one of embodiments 1 to 7, wherein said matrix comprises one or more organic materials, inorganic materials, or composites thereof.
9. The transparent fluorescent structure according to any one of embodiments 1 to 8, wherein said substrate nanoparticles have an average particle size of up to about 100 nm.
10. The transparent fluorescent structure according to any one of embodiments 1 to 9, wherein said substrate nanoparticles have an average particle size within the range of from about 5 nm up to about 75 nm.
11. The transparent fluorescent structure according to any one of embodiments 1 to 10, wherein said substrate nanoparticles have an average particle size of less than or equal to about 20 nm.
12. The transparent fluorescent structure according to any one of embodiments 1 to 11, wherein each fluorescent molecule is covalently bonded to at least one reactive bonding site on the surface of said substrate nanoparticle.
13. The transparent fluorescent structure according to any one of embodiments 1 to 11, wherein each fluorescent molecule is non-covalently bonded to at least one reactive bonding site on the surface of said substrate nanoparticle.
14. The transparent fluorescent structure according to any one of embodiments 1 to 13, wherein each of said fluorescent molecules is attached to at least one of said reactive bonding sites through a surface-bonding group.
15. The transparent fluorescent structure according to any one of embodiments 1 to 13, wherein each of said fluorescent molecules is bonded directly to at least one of said reactive bonding sites.
16. The transparent fluorescent structure of any one of embodiments 1 to 15, wherein the light from each of said fluorescent molecules has a band of wavelengths that at least overlaps the band of wavelengths visible to the normal unaided human eye.
17. The transparent fluorescent structure of any one of embodiments 1 to 16, wherein each said fluorescent molecule fluoresces light having a wavelength outside the band of light visible to the normal unaided human eye.
18. The transparent fluorescent structure of embodiment 17, wherein said transparent fluorescent structure is opaque to visible light but transparent to the light from said fluorescent molecules.
19. The transparent fluorescent structure according to any one of embodiments 1 to 18, wherein said fluorescent molecules are distributed among said substrate nanoparticles such that the amount of fluorescent molecules in said matrix would not produce a sufficiently detectable light intensity, if it were not for said fluorescent molecules being attached to substrate nanoparticles while in said matrix.
20. The transparent fluorescent structure according to any one of embodiments 1 to 18, wherein each of said fluorescent molecules are bonded to the surface of one of said substrate nanoparticles such that said fluorescent molecules exhibit no self-quenching.
21. A fluorescent nanoparticle/matrix precursor dispersion comprising:
a liquid;
at least one polymeric element, with said polymeric element being dissolved in said liquid, suspended as a separate phase in said liquid or both; and
fluorescent nanoparticles dispersed in said liquid,
wherein said dispersion is formable into a fluorescent structure according to any one of embodiments 1 to 20, by removing said liquid, solidifying said liquid or a combination thereof.
   22. A fluorescent nanoparticle/matrix precursor dispersion comprising:
a liquid;
at least one polymeric element, with said polymeric element being dissolved in said liquid, suspended as a separate phase in said liquid or both;
substrate nanoparticles dispersed in said liquid, and
fluorescent molecules dispersed in said liquid,
wherein said dispersion is formable into a fluorescent structure according to any one of embodiments 1 to 20, by removing said liquid, solidifying said liquid or a combination thereof.
   23. The dispersion according to embodiment 21 or 22, wherein said liquid evaporates in a one atmosphere of pressure environment.
   24. The dispersion according to embodiment 21 or 22, wherein said liquid is an uncured polymeric material.
   25. A fluorescent nanoparticle/matrix dispersion comprising:
at least one powdered material; and
fluorescent nanoparticles dispersed in said powdered material,
wherein said dispersion forms said fluorescent structure according to any one of embodiments 1, 2, 5 and 7 to 20.
   26. A fluorescent nanoparticle/matrix precursor dispersion comprising:
at least one powdered material; and
fluorescent nanoparticles dispersed in said powdered material,
wherein said dispersion is formable into the fluorescent structure according to any one of embodiments 1 to 20, by bonding the fluorescent nanoparticle dispersion into one mass.
   27. The dispersion according to embodiment 25 or 26, wherein said at least one powdered material is a powdered polymeric material.
   28. An article comprising a transparent fluorescent structure according to any one of embodiments 1 to 20.
   29. The article according to embodiment 28, further comprising a transparent substrate having a substrate surface, with said transparent fluorescent structure being a layer attached to said substrate surface.
   30. The article according to embodiment 28, further comprising two substrates, with at least one of said substrates being transparent, and said transparent fluorescent structure being a layer attached between said substrate.
   31. The article according to any one of embodiments 28 to 30, wherein said article is a document and said transparent fluorescent structure defines a mechanism for authenticating said document.
   32. The article according to any one of embodiments 28 to 30, wherein said article is a tangible form of identification, and said transparent fluorescent structure defines a mechanism for authenticating said form of identification.
   33. The article according to any one of embodiments 28 to 30, wherein said article is a form of currency and said transparent fluorescent structure defines a mechanism for authenticating said form of currency.
   34. The article according to any one of embodiments 28 to 33, wherein said transparent fluorescent structure is in the form of an appliqué, dried invisible ink, dried paint, cured adhesive, cured clearcoat, cured hardcoat, or a combination thereof.
   35. An article comprising a fluorescent nanoparticle/matrix dispersion according to embodiment 25.
   36. The article according to any one of embodiments 28 to 35, wherein said transparent fluorescent structure emits light that is not visibly detectable by a normal unaided human eye.
   37. The article according to embodiment 36, wherein said transparent fluorescent structure emits light that is not visibly detectable by an unaided human eye, because the intensity of the light is too low, the light has a wavelength outside the band of light visible to the normal unaided human eye, or a combination thereof.
   38. A method of making a transparent fluorescent structure according to any one of embodiment 1 to 20, said method comprising:
providing a plurality of substrate nanoparticles, each substrate nanoparticle having a surface comprising a plurality of reactive bonding sites;
providing a plurality of fluorescent molecules that fluoresce light;
bonding each of at least a portion of the fluorescent molecules to a reactive site on the surface of each of at least a portion of the substrate nanoparticles so as to form a plurality of fluorescent nanoparticles;
providing a matrix precursor suitable for forming a matrix for the fluorescent nanoparticles;
disposing at least a portion of the plurality of fluorescent nanoparticles into the matrix precursor to form a fluorescent nanoparticle dispersion; and
treating the fluorescent nanoparticle dispersion so as to form a transparent fluorescent structure,
wherein the fluorescent nanoparticles in the matrix comprise fluorescent molecules are distributed among the corresponding substrate nanoparticles such that self-quenching of the fluorescent molecules within the transparent fluorescent structure is at least reduced.
   39. A method of making a transparent fluorescent structure, said method comprising:
providing a plurality of substrate nanoparticles, each substrate nanoparticle having a surface comprising a plurality of reactive bonding sites;
providing a plurality of fluorescent molecules that fluoresce light;
bonding each of at least a portion of the fluorescent molecules to a reactive site on the surface of each of at least a portion of the substrate nanoparticles so as to form a plurality of fluorescent nanoparticles;
providing a matrix precursor suitable for forming a matrix for the fluorescent nanoparticles;
disposing at least a portion of the plurality of fluorescent nanoparticles into the matrix precursor to form a fluorescent nanoparticle dispersion; and
treating the fluorescent nanoparticle dispersion so the matrix precursor becomes a matrix with the fluorescent nanoparticles therein, and thereby form a transparent fluorescent structure,
wherein the fluorescent nanoparticles in the matrix comprise fluorescent molecules are distributed among the corresponding substrate nanoparticles such that self-quenching of the fluorescent molecules within the transparent fluorescent structure is at least reduced.
   40. The method according to embodiment 38 or 39, further comprising:
forming the fluorescent nanoparticle dispersion into a shape, before or during said treating.
   41. The method according to embodiment 38 or 39, further comprising:
forming the fluorescent nanoparticle dispersion into an article, before or during said treating.
   42. The method according to any one of embodiments 38 to 41, wherein the fluorescent nanoparticle dispersion comprises a liquid, at least one polymeric element and the fluorescent nanoparticles, the polymeric element is dissolved in the liquid, suspended as a separate phase in the liquid or both, the fluorescent nanoparticles are dispersed in the liquid, and said treating the fluorescent nanoparticle dispersion further comprises removing the liquid from the fluorescent nanoparticle dispersion, converting the liquid to a solid or a combination thereof.
   43. The method according to any one of embodiments 38 to 41, wherein the fluorescent nanoparticle dispersion comprises a liquid, at least one polymeric element, the substrate nanoparticles and the fluorescent molecules, the polymeric element is dissolved in the liquid, suspended as a separate phase in the liquid or both, the fluorescent nanoparticles are dispersed in the liquid, and said treating the fluorescent nanoparticle dispersion further comprises removing the liquid from the fluorescent nanoparticle dispersion, converting the liquid to a solid, or a combination thereof.
   44. The method according to embodiment 42 or 43, wherein the liquid evaporates in a one atmosphere of pressure environment, and said treating causes evaporation of the liquid.
   45. The method according to embodiment 42 or 43, wherein the liquid is an uncured polymeric material, and said treating causes solidification, and optionally curing, of the liquid.
   46. The method according to any one of embodiments 38 to 41, wherein the fluorescent nanoparticle dispersion comprises at least one powdered material and the fluorescent nanoparticles, the fluorescent nanoparticles are dispersed in the powdered material, and said treating the fluorescent nanoparticle dispersion further comprises forming the fluorescent nanoparticle dispersion into one mass.

### EXAMPLES

### Example 1

### Preparation of Fluorescent Coupling Agent

0.4100 g Fluorescent Dye Umbelliferone (Grade II, Aldrich)

20.06 g Solvent Dry Methyl Sulfoxide (DMSO)

0.61 g Surface-Bonding Group Isocyanatopropyltrimethoxy Silane (Gelest), 95%

1 drop Catalyst Di-n-butyl tin dilaurate (Aesar), >94%

Umbelliferone was first dissolved in DMSO then isocyanatopropyltrimethoxy silane was added to the solution and allowed to mix for 16 hrs at 50° C. To ensure reaction completion a drop of di-n-butyl tin dilaurate was added to the solution and allowed to mix at 50° C. for 3 hrs. This preparation can be and has been performed in other solvents, i.e. THF

### Preparation of Hydrophilic Fluorescent Nanoparticles

100 g Nalco 2326 (16.42%) (SiO₂ nano-particles)

10.18 g Silquest A1230 (Dispersion Group)

5.27 g of fluorescent coupling agent

Reaction was conducted at 80° C. for 4 hours with stirring. The final dispersion was 21.25% solids. Fluoresced under a black light. A cotton swab was dipped into this solution and the swab was used to write “Nano” on a paper substrate.

### Comparative Example

Concentrated umbelliferone solution:

0.0081 g umbelliferone 9.9984 g Ethanol

This solution reflects the amount of umbelliferone (# of dye molecule(s)/particle) reacted onto particles presented above for comparison. A cotton swab was dipped into the solution and the swab was used to write “Dye” on a paper substrate. When writing on Teslin, it was noticed that the back of the sample fluoresced green, which could be used as an internal verification. Diluted solutions of umbelliferone-labeled surface modified nanoparticle at 1%, 5%, and 10% silica solids, and respective umbelliferone-only solutions were also evaluated.

### Preparation Of Unmodified Particles

0.5g of fluorescent coupling agent

5 g Ethanol

0.5 mL Nalco 2326 (16.42%)

The fluorescent coupling agent was diluted with ethanol. It fluoresced bright white under a black light. One drop of Nalco 2326 was added to the solution under black light and an immediate intensification of fluorescence was observed. The remaining amount of Nalco 2326 was added to the solution. The intensity of the fluorescence remained the same.

### Preparation of Hydrophobic Fluorescent Nanoparticles

50 g Nalco 2326 (16.42%)

3.27 g Isooctyltrimethoxy silane (Dispersion Group)

0.36 g Methyltrimethoxy silane (95%) (Dispersion Group)

50 g Ethanol

12 g Methanol

6.59 g of fluorescent coupling agent

The fluorescent coupling agent was added to Nalco 2326 first and allowed to mix at 80° C. for 1.5 hrs. Then the silanes were added to the reaction and the resultant mixture was allowed to stir at 80° C. for 16 hrs. The particles were dried using a rotavap and then ground up via mortar and pestle. The off-white powder fluoresced in a black light. The powder was mixed at 0.5% into calcium carbonate—10 μm, shaken up, and evaluated under a black light. Fluorescent specks were visible under a black light.

This invention may take on various modifications and alterations without departing from its spirit and scope. Accordingly, this invention is not limited to the above-described embodiments but is to be controlled by the limitations set forth in the following claims and any equivalents thereof.

1. A transparent fluorescent structure comprising:
a matrix; and
a plurality of fluorescent nanoparticles disposed within said matrix, with said fluorescent nanoparticles comprising a plurality of substrate nanoparticles and fluorescent molecules, and each said fluorescent nanoparticle comprising:
a substrate nanoparticle having a surface; and
one or more fluorescent molecules that fluoresce light, with each fluorescent molecule being directly bonded to a reactive bonding site on the surface of said substrate nanoparticle,
wherein said fluorescent molecules are distributed among said substrate nanoparticles such that self-quenching of said fluorescent molecules is at least reduced.

2. The transparent fluorescent structure according to claim 1, wherein said matrix comprises a continuous solid material, a discontinuous solid material or any combination thereof.

3. The transparent fluorescent structure according to claim 1, wherein said matrix is in the form of a continuous structure, and wherein said matrix is in the form of a web, sheet, film, layer, coating, extrudate, casting, molding or any combination thereof.

4. The structure according to claim 1, wherein said matrix is in the form of a discontinuous structure, and wherein said matrix is in the form of a woven or nonwoven fibrous web, scrim, sheet, layer, paper, fabric, cloth or any combination thereof.

5. The transparent fluorescent structure according to claim 4, wherein said matrix is in the form of a powder.

6. The transparent fluorescent structure according to claim 1, wherein said substrate nanoparticles have an average particle size of up to about 100 nm.

7. The transparent fluorescent structure according to claim 1 any one of claims 1 to 6, wherein each of said fluorescent molecules are bonded to the surface of one of said substrate nanoparticles such that said fluorescent molecules exhibit no self-quenching.

8. A fluorescent nanoparticle/matrix precursor dispersion comprising:
a liquid;
at least one polymeric element, with said polymeric element being dissolved in said liquid, suspended as a separate phase in said liquid or both; and
fluorescent nanoparticles dispersed in said liquid,
wherein said dispersion is formable into a fluorescent structure according to claim 1, by removing said liquid, solidifying said liquid or a combination thereof.

9. A fluorescent nanoparticle/matrix precursor dispersion comprising:
a liquid;
at least one polymeric element, with said polymeric element being dissolved in said liquid, suspended as a separate phase in said liquid or both;
substrate nanoparticles dispersed in said liquid, and
fluorescent molecules dispersed in said liquid,
wherein said dispersion is formable into a fluorescent structure according to claim 1, by removing said liquid, solidifying said liquid or a combination thereof.

10. An article comprising a transparent fluorescent structure according to claim 1.

11. The article according to claim 10, further comprising a transparent substrate having a substrate surface, with said transparent fluorescent structure being a layer attached to said substrate surface.

12. The article according to claim 10, wherein said article is a document and said transparent fluorescent structure defines a mechanism for authenticating said document.

13. The article according to claim 10, wherein said article is a tangible form of identification, and said transparent fluorescent structure defines a mechanism for authenticating said form of identification.

14. The article according to claim 1, wherein said transparent fluorescent structure is in the form of an appliqué, dried invisible ink, dried paint, cured adhesive, cured clearcoat, cured hardcoat, or a combination thereof.

15. A method of making a transparent fluorescent structure according to claim 1, said method comprising:
providing a plurality of substrate nanoparticles, each substrate nanoparticle having a surface comprising a plurality of reactive bonding sites;
providing a plurality of fluorescent molecules that fluoresce light;
bonding each of at least a portion of the fluorescent molecules to a reactive site on the surface of each of at least a portion of the substrate nanoparticles so as to form a plurality of fluorescent nanoparticles;
providing a matrix precursor suitable for forming a matrix for the fluorescent nanoparticles;
disposing at least a portion of the plurality of fluorescent nanoparticles into the matrix precursor to form a fluorescent nanoparticle dispersion; and
treating the fluorescent nanoparticle dispersion so as to form a transparent fluorescent structure,
wherein the fluorescent nanoparticles in the matrix comprise fluorescent molecules are distributed among the corresponding substrate nanoparticles such that self-quenching of the fluorescent molecules within the transparent fluorescent structure is at least reduced.
